(19) United States
(12) Patent Application Publication
(10) Pub. No.: US 2024/0120714 A1
(43) Pub. Date: Apr. 11, 2024

(54) DC POWER SYSTEM FOR MODULAR WORKSTATIONS

(71) Applicant: MillerKnoll, Inc., Zeeland, MI (US)

(72) Inventors: Peter James Keyzer, Holland, MI (US); Matthew James Lilley, Walker, MI (US); Adam Daley-Fell, Zeeland, MI (US); John F. Aldrich, Grandville, MI (US); Robert W. Roth, Holland, MI (US)

(21) Appl. No.: 18/484,312

(22) Filed: Oct. 10, 2023

Related U.S. Application Data
(60) Provisional application No. 63/414,830, filed on Oct. 10, 2022.

(51) Int. Cl. H02B 1/20; G06F 1/18; G06F 1/26; H02H 7/20

(52) U.S. Cl. CPC H02B 1/20; G06F 1/189; G06F 1/263; H02H 7/20

(57) ABSTRACT

A workspace includes a power input receptacle configured to receive an input power at a first voltage level, wherein the first voltage level is an extra-low voltage. The workspace further includes a voltage regulator configured to regulate the input power and output a regulated power at a second voltage level and a power distribution bus. The power distribution bus is configured to receive the input power from the power input receptacle. The workspace further includes a safety disconnect configured to disconnect the input power from the power distribution bus in response to detecting an adverse condition.

### CROSS-REFERENCE TO RELATED APPLICATIONS

This application claims priority to, and the benefit of, U.S. Provisional Patent Application No. 63/414,830, filed Oct. 10, 2022, the contents of which are hereby incorporated by reference in their entirety.

### FIELD OF THE INVENTION

The present invention relates to furniture systems and, more particularly, to mechanisms for distributing power within a furniture system.

### SUMMARY

The present embodiment provides, in one aspect, a workspace including a power input receptacle configured to receive an input power at a first voltage level, wherein the first voltage level is an extra-low voltage. The workspace further includes a voltage regulator configured to regulate the input power and output a regulated power at a second voltage level and a power distribution bus. The power distribution bus is configured to receive the input power from the power input receptacle. The workspace further includes a safety disconnect configured to disconnect the input power from the power distribution bus in response to detecting an adverse condition.

The present embodiment provides, in another aspect, a workspace system including a power distribution device and one or more mobile workspaces. The power distribution device includes a power converter configured to convert a utility power to a distribution power at a first voltage level, and a power rail configured to receive the distribution power from the power converter. The first voltage level is an extra-low voltage level. The one or more workspaces each include a power input receptacle configured to be removably electrically coupled to the power rail to receive the distribution power, and a power distribution bus configured to provide the received distribution power to one or more devices.

The present embodiment provides, in yet another aspect, a height adjustable workspace including a tabletop, a leg coupled to the tabletop, a power input receptacle configured to receive an input power, and an auxiliary power source configured to receive the input power. The input power is a DC power. The height adjustable workspace further includes a power distribution bus configured to receive the input power, a voltage regulator coupled to the power distribution bus and configured to output a first regulated voltage, and an actuator positioned within the leg. The actuator is configured to raise and lower the tabletop and is further configured to receive power from the power distribution bus. The height adjustable workstation further includes one or more auxiliary power ports that are configured to receive power from the power distribution bus.

### BRIEF DESCRIPTION OF DRAWINGS

FIG. 1 is a front view of a height adjustable workstation, according to some embodiments.

FIG. 2 is a rear view of the height adjustable workstation of FIG. 1.

FIG. 3 is a block diagram of a height adjustable workstation, according to some embodiments.

FIG. 4 is a system view of a multiple workstation system, according to some embodiments.

FIG. 5 is a block diagram of the multiple workstation system of FIG. 4, according to some embodiments.

FIG. 6 is a block diagram of a multiple workstation system using an integral power rail system, according to some embodiments.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

The embodiments described herein relate generally to various furniture systems and pieces, such as workstations (e.g., desks, including height adjustable desks), display walls, battery carts, cubicles, and/or other furniture as required for a given application. While the embodiments described herein generally relate to business and/or workplace furniture, it is contemplated that the power distribution systems and controls described below may be used in other furniture systems, such as commercial or residential furniture systems.

The below described furniture systems are configured to allow for a single point connection to an extra-low power connection, such as a DC voltage connection below 50 VDC. The various components of the furniture systems (e.g., desks, display walls, battery carts, etc.) may be able to receive the single extra-low power connection and distribute and/or convert the input voltage to other voltages as required for a given application. This allows for multiple devices (e.g., actuators, USB devices, monitors, lights, etc.) to be powered via the single input power connection. Furthermore, as the input power is an extra-low voltage level, the various components of the furniture system are able to be more easily moved or reconfigured as needed without requiring qualified personnel (e.g., electricians) to provide power to the furniture system components. The individual furniture system components may further be configured to connect to each other to allow for power to be distributed from component to component with only a single connector to the power source being required, thereby providing additional flexibility of the furniture system.

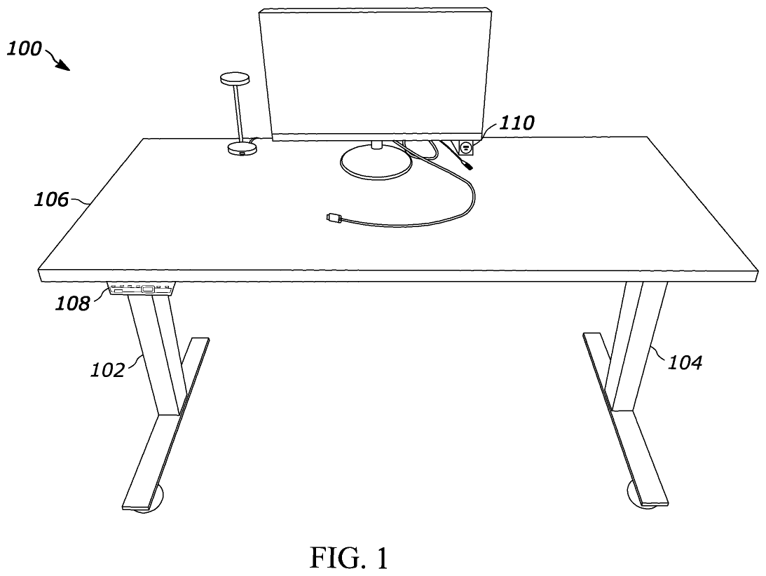

Turning now to FIG. 1, a front view of an example workstation 100 is shown, according to some embodiments. The workstation 100 is shown as a height adjustable desk, having a first leg 102, a second leg 104, and a tabletop 106. The workstation 100 may further include a control panel 108 for adjusting a height of the workstation 100. The workstation 100 may further include one or more power ports 110, which will be described in more detail below.

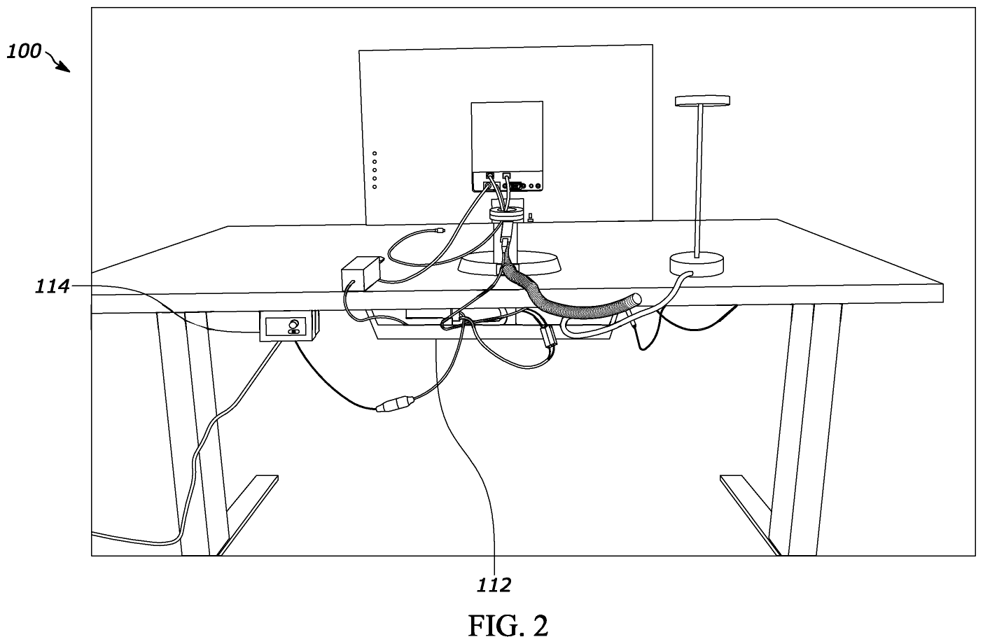

FIG. 2 is a rear view of the workstation 100, showing a power control enclosure 112. The power control enclosure 112 may be attached to an underside of the tabletop 106. However, in other embodiments, the power control enclosure 112 may be integrated into the tabletop 106, attached to and/or integrated into one of the first leg 102 and the second leg 104, or otherwise placed on a portion of the workstation 100. The workstation 100 may further include a power input port 114. As shown in FIG. 2, the power input port 114 is separate from the power control enclosure 112. However, in some embodiments, the power input port 114 may be integrated into the power control enclosure. Alternatively, the power input port 114 may be integrated into one of the components of the workstation 100, such as the first leg 102, the second leg 104, and/or the tabletop 106. As will be described in more detail below, the power input port 114 is configured to receive a DC power input.

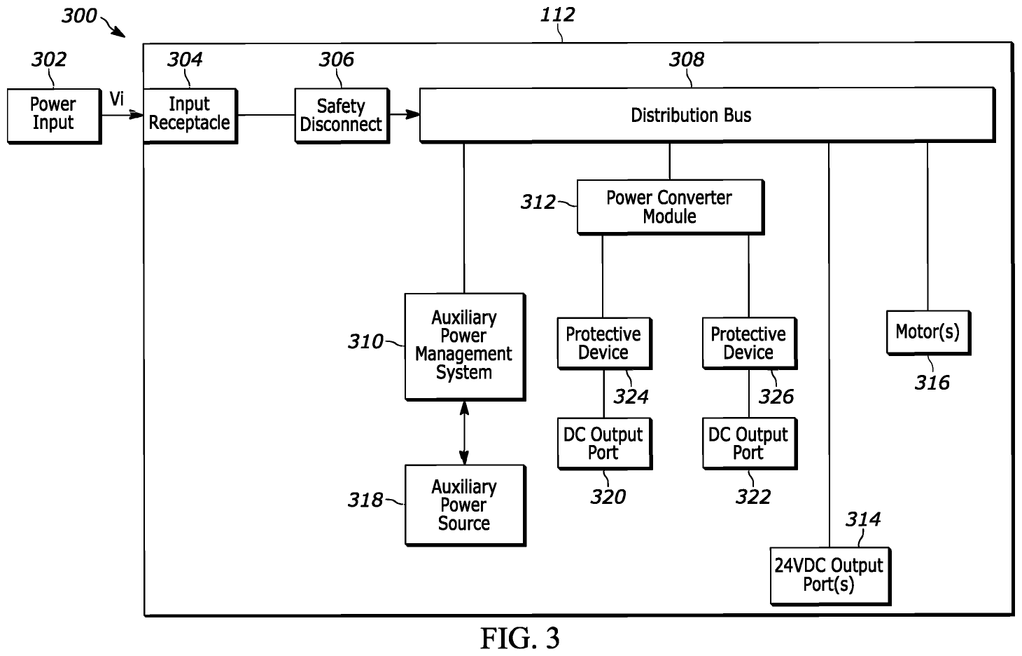

Turning now to FIG. 3, a block diagram of a power control system 300 of a workstation, such as workstation 100, is shown according to some embodiments. The power control system 300 is shown as being located within the power control enclosure 112; however, it is contemplated that one or more of the components of the power control system 300 may be positioned or located outside of the power control enclosure 112. The power control system 300 may receive input power (“Vi”) from a power input 302. The power input 302 may be a DC power supply that is configured to supply a DC voltage to an input receptacle 304 of the power control system 300. In one embodiment, the input receptacle 304 is similar to the power input port 114 described above. In one example, the power input 302 may be an AC-DC converter that converts a standard utility AC voltage (e.g., 120 VAC, 240 VAC, etc.) to one or more DC voltages (e.g., 30 VDC, 24 VDC, 12 VDC, 5 VDC, and/or other voltage levels) as required for a given application. In other examples, the power input 302 may be a DC power supply configured to output one or more DC voltages. The power input 302 is configured to provide one or more DC voltages to the power control system 300, such as 24 VDC. However, DC voltages of more than 24 VDC or less than 24 VDC are also contemplated, as described above. In one embodiment, the input voltage is an extra-low voltage (e.g., less than 50 VDC).

The input power Vi is provided from the input receptacle 304 to a safety disconnect 306, according to some embodiments. The safety disconnect 306 may be configured to sense one or more parameters associated with the input voltage Vi and perform a safety operation (e.g., disconnecting the input power Vi from the remaining components of the power control system 300) based on the sensed parameters. For example, the safety disconnect 306 may be configured to detect one or more of an input voltage and an input current. The safety disconnect 306 may further be configured to determine other parameters, such as temperature (such as of a distribution bus as described below), ripple current, ground fault data, short circuit data, and/or other parameters as required for a given operation. The safety disconnect 306 may perform the safety operation in response to one or more sensed values exceeding a threshold value, such as threshold values associated with an over-voltage condition, an under-voltage condition, an over-current condition, an over-temperature condition, a short circuit condition, a ground fault condition, or other conditions as required for a given application. In some examples, the safety disconnect 306 may be a switch (e.g., a mechanical switch, a solid-state switch, a smart switch, and/or an electronically controlled switch), a fuse, a circuit breaker, or other device as required for a given application.

In some embodiments, the safety disconnect 306 may be programmable to allow a user to set the one or more threshold values. For example, a user may be able to set the preferred voltage level of Vi (e.g., 24 VDC, 12 VDC, 5.5 VDC, etc.) as required for a given application. This can allow for the versatility by facilitating a single safety disconnect 306 to be used with various workstation types.

The input power Vi is then provided to a distribution bus 308. The distribution bus 308 may be a busbar, a terminal block, or other application power distribution device. The distribution bus 308 is configured to provide power to one or more components within the power control system 300. For example, as shown in FIG. 3, the distribution bus 308 provides the input power Vi to an auxiliary power management system 310, a power converter module 312, one or more DC output ports 314, and one or more motors 316. In some examples, the distribution bus 308 may include multiple power busses, such as two power busses and a common bus, thereby allowing for multiple inputs to be provided to the workstation 100 via the power input 302. This may be useful where there are multiple electrical loads on the workstation 100, such that the loads may be balanced across the two power busses. In other examples, the distribution bus 308 may include multiple power busses having different voltages. For example, a first power bus of the distribution bus 308 may be a 24 VDC power bus, and a second power bus of the distribution bus may be a 12 VDC power bus. However, the one or more additional power busses of the distribution bus may include additional voltage levels, as required for a given application.

The auxiliary power management system 310 is in electronic communication with an auxiliary power source 318. In one embodiment, the auxiliary power source 318 is an energy storage device, such as a battery. The battery may be a lithium-ion battery, a lithium iron phosphate battery, a lead acid battery, or other battery type as required for a given application. Other possible energy storage devices may include super capacitors, fuel cells, or other applicable energy storage devices. The auxiliary power source 318 is configured to provide power to the distribution bus 308, such as via the auxiliary power management system 310, in the event that the input power Vi is lost, which may occur when moving the workstation 100 from one location to another or if utility power is lost. This allows for full, yet temporary, operation of the workstation 100 even when disconnected from the power input 302. In some embodiments, the auxiliary power source 318 may also or alternatively provide supplemental power to the distribution bus 308 in the event the input power Vi is insufficient. For example, if multiple devices are connected to and drawing power from the distribution bus 308, the auxiliary power source 318 may supplement the input power Vi. In one example, the auxiliary power source 318 may supplement power to the distribution bus 308 when the input power Vi drops below a predetermined threshold. The predetermined threshold may be 85% of the optimal Vi value; however, values of more than 85% or less than 85% are also contemplated as required for a given application. When input power Vi is available, the auxiliary power source 318 is charged, as needed, by the auxiliary power management system 310.

The power converter module 312 receives power from the distribution bus 308 and is configured to convert the input power Vi into one or more additional voltages for further distribution within the workstation 100. For example, the power converter module 312 may reduce the input voltage (e.g., 24 VDC) to one or more lower voltages, such as 12 VDC, 5 VDC, 3.3 VDC, etc. In other examples, the power converter module 312 may also increase the input voltage Vi to a higher voltage, such as 48 VDC. However, other voltages are also contemplated as required for a given application. The power converter module 312 may provide power to one or more auxiliary output ports 320, 322. The auxiliary output ports 320, 322 may be USB-A ports, USB-C ports, or other applicable output ports as required for a given application. The auxiliary output ports 320, 322 may each have a protective device 324, 326 (respectively) between the auxiliary output ports 320, 322 and the power converter module 312. The protective devices 324, 326, may be fuses, circuit breakers, or other protective devices configured to protect the output of the auxiliary ports in the event of an event, such as an overvoltage event, an overcurrent event, a ground fault event, a short-circuit event, or other event/fault as required for a given application. While shown as only having two auxiliary output ports 320, 322, it is contemplated that a workstation may have more than two auxiliary output ports or less than two auxiliary output ports. Furthermore, a workstation 100 may have multiple types of auxiliary output ports, as required for a given application. In some examples, the auxiliary output ports 320, 322 may further include voltage regulators to allow for the output voltage provided by the power converter module 312 to be further regulated. For example, where the power converter module 312 is configured to output a 12 VDC voltage, one or more of the auxiliary output ports may be configured to further regulate the voltage to a lower voltage, such as 5 VDC or 3.3 VDC as required for a given application.

The one or more output ports 314 may provide the input power Vi to one or more external devices, such as monitors, displays, lights, etc. The one or more output ports 314 may utilize one or more port types, such as USB ports, barrel connectors, magnetic connectors, etc.

The one or more motors 316 may be used to raise and/or lower an adjustable height workstation. Thus, in some examples, the motors 316 may be omitted where the workstation is not an adjustable height workstation. The motors 316 may be coupled directly to the distribution bus 308 to receive the input power Vi. In some embodiments where there are two or more motors, the motors 316 may communicate with each other via a communication protocol, such as LIN communication. However, other communication protocols are also contemplated as required for a given application. While not shown, the workstation 100 may further include one or more motor controllers and a user input to allow for control of the one or more motors 316. In one embodiment, the motors 316 may be actuators, such as linear actuators.

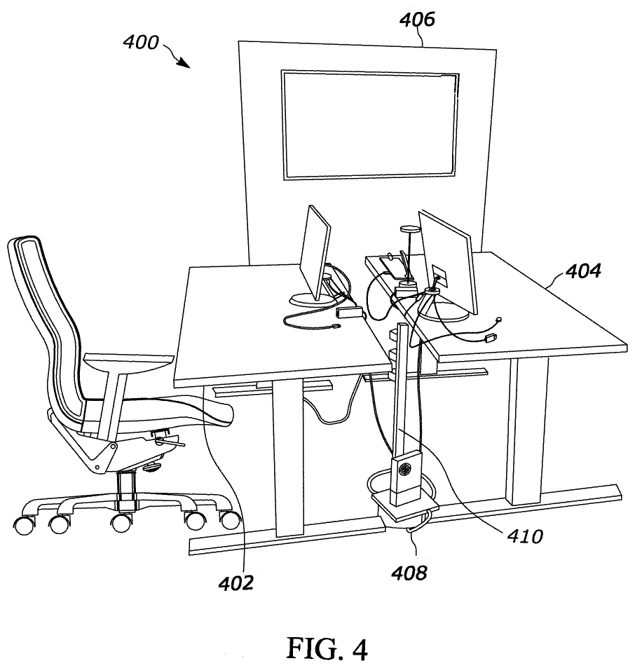

Turning now to FIG. 4, a multiple workstation system 400 is shown with a first desk 402, a second desk 404, and a display board 406. Each of the first desk 402, the second desk 404, and the display board 406 may include a power control system, similar to the power control system 300 described above. The system 400 may further include a power source 408. The power source 408 may be an AC to DC converter configured to regulate an AC utility power to a lower DC voltage, such as 24 VDC. The power source 408 may be coupled to a power rail 410. The power rail 410 may be configured to receive the output voltage of the power source and include one or more connection points to allow for the various workstations (e.g., the first desk 402, the second desk 404, and/or the display board 406) to be electrically coupled to the power rail 410. In some embodiments, the first desk 402, the second desk 404, and/or the display board 406 may be configured to couple to the power rail using a connector 450. In some embodiments, the connectors 450 may be a quick-turn. In some examples, a magnetic connector, such as a Magna-Plug® from Exceltec may be used as the connector 450. Use of a magnetic connector protects the power rail 410 and or the associated workstation for damage in the event excess stress is put on the connector 450, such as when the workstations are being move or otherwise rearranged. However, other connectors are also contemplated as required for a given application.

In some examples, the power rail 410 may receive more than one voltage output from the power source 408, and/or be coupled to multiple power sources 408 having different output voltages. For example, the power rail 410 may be configured to provide multiple voltage connections, such as 30 VDC, 24 VDC, 12 VDC, and/or other voltage levels as required for a given application. This can allow for different workstations to be coupled to the same power rail, without requiring all the associated workstations to include circuitry to regulate the voltage on a single voltage power rail 410 (e.g., 24 VDC). For example, a height adjustable workstation having one or more motors may connect to a higher potential voltage output of the power rail, such as 30 VDC or 24 VDC; while a non-height adjustable workstation may connect to a lower potential voltage output of the power rail, such as 12 VDC.

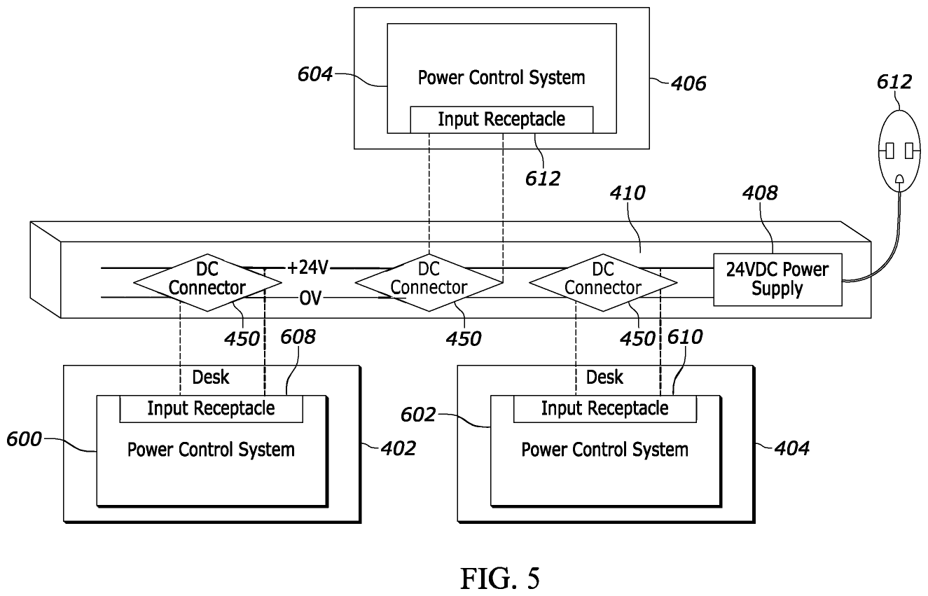

FIG. 5 is a block diagram of a multiple workstation system, such as the multiple workstation system 400. The first desk 402 includes a power control system 600, the second desk 404 includes a power control system 602, and the display board includes a power control system 604. The power control systems 600, 602, 604 may be similar to the power control system 300 described above. For example, the power control systems 600, 602 may include the same or additional components as the power control system 300 described above, while the power control system 604 may not include the one or more motors 316. However, in some examples, the display board 406 may be height adjustable and may include one or more motors to allow for the display portion of the display board to be raised and/or lowered.

As shown in FIG. 5, the power control systems 600, 602, 604 receive power at the input receptacles 608, 610, 612, respectively. The input receptacles 608, 610, 612 may be similar to the input receptacle 304, described above. The input receptacles 608, 610, 612 are coupled to the power rail 410 of the power source 408 using a connector 614, such as those described above. However, other connection devices and methods are also contemplated as required by a given application. The input power is then distributed and/or regulated using the power control systems 600, 602, 604 as described above. The power source 408 is coupled to, and receives power from, a utility power connection via input receptacle 612, such as a 120 VAC or 240 VAC supply. However, other utility voltages are also contemplated. While FIG. 5 shows three workstations coupled to the power rail 410, it is contemplated that multiple workstations, of varying or similar types, may be coupled to the power rail. This can allow for various combinations of workstations to be arranged in a given location and connected to an extra-low voltage via the power rail 410. As described above, the power rail 410 may include multiple voltage levels to allow for various types of workstations to be coupled to the power rail.

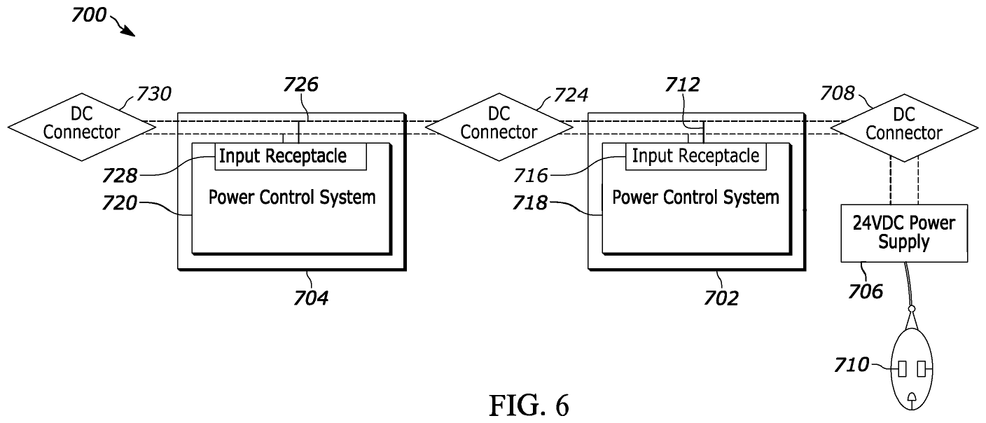

Turning now to FIG. 6, a block diagram of an interconnectable workstation system 700 is shown, according to some embodiments. The system 700 is shown as having a first workstation 702 and a second workstation 704; however, it is contemplated that the system 700 may include more than two workstations. As shown in FIG. 6, a power source 706 may provide an extra-low voltage (e.g., 24 VDC) to a first DC connector 708 on the first workstation 702. In some embodiments, the DC connector 708 is similar to one or more of the connectors described above, such as quick-turn and/or magnetic connectors. However, other connector types are also contemplated as required for a required application. The power source 706 is coupled to a utility power supply 710, such as a 120 VAC utility power. The DC connector 708 may be coupled to an integral power rail 712 of the first workstation 702. The integral power rail 712 may provide power to a power control system 714 of the first workstation 702 via an input receptacle 716. In one embodiment, the input receptacle 716 is similar to the input receptacle 304 described above. In some examples, the integral power rail 712 may be coupled to a distribution bus of one or more power control systems 718, 720 of the first workstation 702 and the second workstation 704, respectively.

The first workstation 702 may further include a second DC connector 722 which is configured to couple with a first DC connector 724 of the second workstation 704, thereby providing power to an integral power rail 726 of the second workstation 704, which may be coupled to an input receptacle 728 of the second workstation 704. The second workstation 704 may further include a second DC connector 730 for coupling to additional workstations (not shown). The DC connectors described above may further be configured to allow for two or more voltage levels to be passed from workstation to workstation, thereby further increasing the flexibility of the system 700.

Although the invention has been described in detail with reference to certain preferred embodiments, variations and modifications exist within the scope and spirit of one or more independent aspects of the invention as described. Various features and advantages of the invention are set forth in the following claims.

What is claimed is:

1. A workspace, comprising:
a power input receptacle configured to receive an input power at a first voltage level, wherein the first voltage level is an extra-low voltage;
a voltage regulator configured to regulate the input power and output a regulated power at a second voltage level;
a power distribution bus, wherein the power distribution bus is configured to receive the input power; and
a safety disconnect configured to disconnect the input power from the power distribution bus in response to detecting an adverse condition.

2. The workspace of claim 1, further comprising one or more ancillary power outputs, wherein the one or more ancillary power outputs receive power via the voltage regulator.

3. The workspace of claim 2, wherein the one or more ancillary power outputs are configured to output an accessory power output at a third voltage level.

4. The workspace of claim 1, wherein the second voltage level is greater than the first voltage level.

5. The workspace of claim 1, wherein the second voltage level is less than the first voltage level.

6. The workspace of claim 1, further comprising an auxiliary power source configured to receive the input power and output an auxiliary power.

7. The workspace of claim 6, wherein the first voltage level is a level configured to charge the auxiliary power source.

8. The workspace of claim 1, further comprising an actuator configured to raise and lower a worksurface of the workspace, wherein the actuator is configured to receive power via the power distribution bus.

9. The workspace of claim 1, wherein the adverse condition is one or more of an over-voltage condition and an over-current condition.

10. The workspace of claim 1, wherein the safety disconnect is programmable to set a threshold associated with the adverse condition.

11. A workspace system, comprising:
a power distribution device, including:
a power converter to convert a utility power to a distribution power at a first voltage level, wherein the first voltage level is an extra-low voltage; and
a power rail, wherein the power rail receives the distribution power from the power converter;
one or more mobile workspaces, each of the one or more mobile workspaces including:
a power input receptacle configured to be removably electrically coupled to the power rail to receive the distribution power; and
a power distribution bus configured to provide the received distribution power to one or more devices.

12. The workspace system of claim 11, further comprising an auxiliary power source configured to provide an auxiliary power to the power distribution bus in response to the first voltage level falling below a predetermined threshold.

13. The workspace system of claim 11, wherein the one or more mobile workspaces further include a voltage regulator coupled to the power distribution bus and configured to output a regulated power different from the distribution power.

14. The workspace system of claim 13, wherein the regulated power has a lower voltage than the distribution power.

15. A height adjustable workspace, comprising:
a tabletop;
a leg coupled to the tabletop;
a power input receptacle configured to receive an input power, wherein the input power is a DC power;
an auxiliary power source configured to receive the input power;
a power distribution bus, wherein the power distribution bus is configured to receive the input power;
a voltage regulator coupled to the power distribution bus and configured to output a first regulated voltage;
an actuator positioned within the leg and configured to raise and lower the tabletop, wherein the actuator is further configured to receive power from the power distribution bus; and
one or more auxiliary power ports configured to receive power from the power distribution bus.

16. The height adjustable workspace of claim 15, further comprising one or more ancillary power output ports, wherein the one or more ancillary power output ports receive power at the first regulated voltage via the voltage regulator.

17. The height adjustable workspace of claim 16, wherein the one or more ancillary power output ports are configured to output a second regulated voltage.

18. The height adjustable workspace of claim 16, wherein the one or more ancillary power output ports include a USB-C port.

19. The height adjustable workspace of claim 15, further comprising a safety disconnect configured to disconnect the input power from the power distribution bus in response to detecting an adverse electrical condition.

20. The height adjustable workspace of claim 15, wherein the auxiliary power source is configured to provide an auxiliary power to the power distribution bus in response to the input power being removed.
